(19) United States
(12) Patent Application Publication
(10) Pub. No.: US 2010/0039439 A1
(43) Pub. Date: Feb. 18, 2010

(54) MAGNETIC RESONANCE IMAGING SYSTEM WITH DISPLAY

(75) Inventors: Hans Hermanus Tuithof, Eindhoven (NL); Dirk Sinnema, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 11/917,970

(22) PCT Filed: Jun. 28, 2006
(86) PCT No.: PCT/IB2006/052163

§ 371 Date: Dec. 18, 2007

(30) Foreign Application Priority Data
Jun. 30, 2005 (EP) 05105883.2

(51) Int. Cl. G09G 5/02

(52) U.S. Cl. 345/589; 345/440

(57) ABSTRACT

A magnetic resonance imaging system comprises a main magnet to apply a stationary magnetic field in a magnetic field zone that includes an examination zone A display is positioned within the magnetic field zone. The display is a multi-stable display in which individual pixels have several brightness states. Notably, the display is based on an e-ink technology.

The invention pertains to a magnetic resonance imaging system comprising a display.

The commercial brochure Achieva 3.0T Quasar product release 1.2 shows a magnetic resonance imaging system in which an LCD (liquid crystal display) display monitor is mounted on a flange of the main magnet. Another LCD display is mounted on an articulated arm that can be moved close to the magnetic resonance imaging system and within the fringe field of the main magnetic field.

The LCD displays of the known Achieva 3.0T Quasar magnetic resonance imaging system require somewhat complex electromagnetic shielding to avoid interference due to the operation of the LCD display on the operation of the magnetic resonance imaging system, notably on the acquisition of magnetic resonance signals.

An object of the invention is to provide a magnetic resonance imaging system in which a simpler electromagnetic screening of the display is employed or electromagnetic screening of the display can be dispensed with.

This object is achieved according to the magnetic resonance imaging system of the invention which comprises

a main magnet to apply a stationary magnetic field in a magnetic field zone that includes an examination zone

a display positioned within the magnetic field zone

the display including a multitude of pixels, wherein

the display is a multi-stable display in which individual pixels have several brightness states.

The multi-stable display of the magnetic resonance imaging system of the invention has pixels that have respective brightness states. The individual pixels have stable states, each having a brightness value for the pixel at issue. By placing individual pixels at respective brightness states an image can be displayed. A particular simple example of a multi-stable display has pixels that each have two brightness states, e.g. a dark and a bright state. Such a bi-stable display is capable of displaying monochrome (black-white) images. The multi-stable display shows a stationary images without the need of electronic signals once the pixels have been set. Hence the multi-stable display does not electro-magnetically interfere during display of the stationary image with the operation of the magnetic resonance imaging system. Experiments have shown that the stationary image on the multi-stable display is not affected by running a magnetic resonance acquisition sequence, like a TFE acquisition sequence. Notably, the multi-stable display is not sensitive to the electro-magnetic fields employed by the magnetic resonance imaging system. These electromagnetic fields include the static main magnetic field of the main magnet, but also include temporary magnetic gradient fields applied by a gradient coil system and RF-fields emitted by an RF-emission system. The magnetic gradient fields serve for spatial encoding of the magnetic resonance signals. The RF fields are employed for excitation of (nuclear or electron) spins in the object to be examined or for refocusing or inversion of the spins. Electromagnetic screening of the display can be dispensed with when refreshing of the image on the display is disjoint in time from actual reception of magnetic resonance signals by the signal acquisition system of the magnetic resonance imaging system. Simple, low-grade electromagnetic screening of the display allows image refreshment during reception of magnetic resonance signals.

The display of the magnetic resonance imaging system of the invention may be employed to display magnetic resonance images that are reconstructed from the magnetic resonance signals acquired by the magnetic resonance imaging system. Further, other kinds of image information, such as related to control of the magnetic resonance imaging system or related to physiological information of the patient to be examined.

These and other aspects of the invention will be further elaborated with reference to the embodiments defined in the dependent Claims.

According to one aspect of the invention the individual pixels of display has pixels that comprise a capsule in which a fluid and a multitude of particles are enclosed. The opacities of the fluid and of the particles are different. The particles are moveable within the capsule. The brightness state of the pixel is set according to the spatial distribution of the particles in the capsule. For example when the particles accumulate at the side of the capsule towards the viewer, the viewer perceives the opacity of the particles. When the particles accumulate at the side of the capsule remote from the viewer, then the viewer perceives the opacity of the fluid. Graded perceived opacity values are obtained by gradual degrees of accumulation of the particles.

According to another aspect of the invention, the particles in the capsule are moved under the influence of an applied electric field. In this aspect of the invention the accumulation of the particles in the capsule occurs under the influence of the electrophoresis effect. In another version, electrically charges particles are employed. This allows accumulation of the particles within the capsule without the need of mechanically moving parts. Depending on the field strength of the applied electric field to the particles in the capsule, the accumulation of particles within the capsule can be graded.

According to a particular aspect of the invention, particles of different opacities, notably two classes are employed: one class of high-opacity particles and another class of low-opacity particles are used. In particular the particles of different opacity classes have opposite electrical charges so that particles having different opacities move to opposite ends of their capsule under the influence of the electric field.

According to a further aspect of the invention, the display comprises several control electrodes and a common counter electrode. The capsules are located between the common counter electrode and one or several of the control electrodes. These control electrodes and common counter electrode provide the applied electric field to the particles in the capsules by selectively activating individual control electrodes and applying a fixed electric potential to the common counter electrode. An individual capsule may be associated with several control electrodes. The gradation of the accumulation of particles in the individual capsule can be controlled on the basis of the number of control electrodes that are activated. When all control electrodes associated with the capsule at issue are activated at a potential the particles accumulate to a large extent at one side of the capsule, depending on the polarity of the applied electric field and the polarity of the electric charge or electric dipole of the particles. Thus, depending on the sign of the potential difference applied to the control electrodes and the common counter electrode, the particles accumulate either at the side of the capsule towards or remote from the viewer. When only part of the control electrode associated with an individual capsule are activated, the accumulation at either sides of the capsule occurs to an extent depending on the number of control electrodes that are activated. Also, the viewing angle of the displayed image can be set by activating only some of the control electrode associated with an individual capsule. Notably, the viewing angle extends along the direction extending from the activated control electrode and the centre of the capsule.

These and other aspects of the invention will be elucidated with reference to the embodiments described hereinafter and with reference to the accompanying drawing wherein

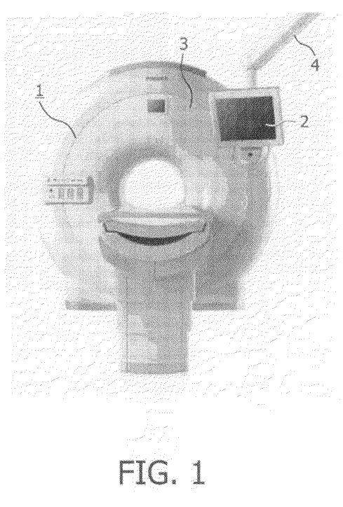

FIG. 1 shows a magnetic resonance imaging system with several displays in which the invention is employed and

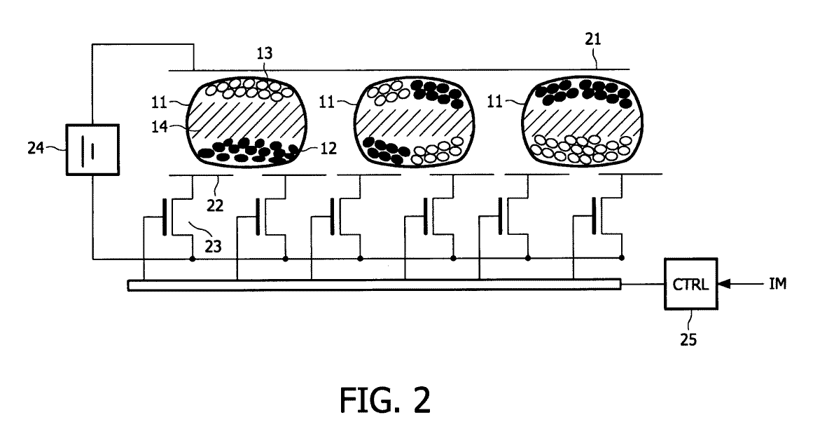

FIG. 2 schematically shows a multistable display of the magnetic resonance imaging system according to the invention.

FIG. 1 shows a magnetic resonance imaging system with several displays in which the invention is employed. Notably, the magnetic resonance imaging system comprises a magnet system 1 with a bore in which the patient to be examined van be positioned. There is a display 2 provided on the housing of a flange of the magnet system 1. Another display 3 is mounted on an articulated arm 4. According to the invention the displays 2,3 are multistable displays. The main magnetic field strength of the magnetic resonance imaging system is about 3.0 T within the bore, but there is a substantial portion of the magnetic field that extends outside the magnet bore. The multistable displays 2,3 operate well within the fringe magnet field that extends beyond the bore of the magnet system. Notably, the multistable display operate without detrimental effects of the fringe magnetic field on the image quality of the image displayed on the multi-stable display within the fringe field containment within which the fringe field drops to 1 Gauss. This fringe field containment has a size of about 5×3 m (axial×radial). The multi-stable display also functions adequate within the zone where the field strength drops to 1 T, which zone extends about 1 m (radially and axially) from the isocentre (where the field strength is about 3 T) of the magnet system 1.

FIG. 2 schematically shows a multistable display of the magnetic resonance imaging system according to the invention. For simplicity, in FIG. 2 only three pixels are shown. However, in practice multistable displays of large number e.g. 1280×1024 pixels may be employed. An individual pixel comprises a capsule 13 in which there is disposed a fluid 14, a large number of high-opacity particles 12 and a large number of low-opacity particles 14. The opacity of the fluid 14 differs from at least one of the opacities of the particles e.g. different from the high-opacity of the high-opacity particles 12. The opacity of the fluid may be different of the same of the opacity of the other class of particles. The particles of the respective classes of high-opacity and low-opacity are electrically charged. The particles of different opacity classes have electric charges of opposite polarity. For example high-opacity particles have negative charges and low-opacity particles have positive charges

The capsules 11 are disposed between the common counter electrode 21 and a system of control electrodes 22. The common counter electrode is coupled to a voltage source 24 and maintained at a fixed electric potential. The control electrodes are coupled to the voltage source 24 via a system of switches 23. The switches are controlled by a control unit 25. When a positive electric potential is applied to the control electrodes 22 of a capsule 11, then the high-opacity particles will accumulate at the side of the capsule nearest tot the control electrode. Because charges of equal sign will repel each other, the low-opacity particles are forced towards the common counter electrode. The common control electrode is transparent, e.g. an indium-tin oxide (ITO) layer. Thus, the viewer looking at the capsule from the side of the common control electrode perceives a low-opacity, e.g. white pixel. Reversing the polarity applied to the control electrode 22 will cause low-opacity particles to accumulate in the capsule nearest to the control electrode while the high-opacity particles are forced towards the transparent common counter electrode 21. Thus a high-opacity perception of the pixel is achieved, that is a black pixel is created. This principle of creating black and white pixels on the basis of moving high-opacity and low-opacity particles on the basis of controlled applied electric field is known per se as ‘e-ink technology’. The capsules have a diameter of e.g. 50-100 μm and the individual particles in the capsules are less than 1 μm in diameter.

By applying positive or negative charges in pinprick patterns across the “page,” the black and white specks can be arranged to make letters and words that look just like those printed with ink on paper.

Unlike standard computer and PDA displays, which generate tiny points of light, the e-ink system simply reflects ambient light off its white background, like a newspaper or book. So it is easily read outdoors in bright sun and at virtually any reading angle. Light-emitting screens are difficult to read in bright places and must be viewed fairly straight on.

The e-ink system also draws far less power than light-emitting systems because it needs energy only to set the image, which remains visible without additional power until it's time to “turn the page”—that is, call up the next image.

1. A magnetic resonance imaging system comprising
a main magnet to apply a stationary magnetic field in a magnetic field zone that includes an examination zone
a display positioned within the magnetic field zone
the display including a multitude of pixels, wherein
the display is a multi-stable display in which individual pixels have several brightness states.

2. A magnetic resonance imaging system as claimed in claim 1, wherein
an individual pixel comprises a capsule containing particles and a fluid
the particles having an opacity that is different from the fluid's opacity.

3. An magnetic resonance imaging system as claimed in claim 2, wherein the capsule includes at least two different classes of particles, respective classes having particles of different opacities.

4. A magnetic resonance imaging system as claimed in claim 2, wherein the particles are controllably moveable within their respective capsules.

5. A magnetic resonance imaging system as claimed in claim 4, wherein the particles are controllably moveable within their respective capsules under the influence of a switchable electric field.

6. A magnetic resonance imaging system as claimed in claim 5,
comprising several control electrodes and a common counter electrode and wherein
individual capsules are located between at least one of the control electrodes and the common counter electrodes.
